(19) United States
(12) Patent Application Publication
(10) Pub. No.: US 2015/0197229 A1
(43) Pub. Date: Jul. 16, 2015

(54) Electrohydraulic Motor Vehicle Brake System and Method for Operating the Same

(71) Applicant: Lucas Automotive GmbH, Koblenz (DE)

(72) Inventors: Josef Knechtges, Mayen (DE); Nicholas Alford, Waldesch (DE); Alexander Pinl, Wolken (DE)

(73) Assignee: Lucas Automotive GmbH, Koblenz (DE)

(21) Appl. No.: 14/394,909

(22) PCT Filed: Nov. 28, 2013
(86) PCT No.: PCT/EP2013/074926

§ 371 Date: Oct. 16, 2014

(30) Foreign Application Priority Data
Dec. 21, 2012 (DE) 10 2012 025 247.1

(51) Int. Cl. B60T 13/68; B60T 13/14; B60T 7/04

(52) U.S. Cl. CPC B60T 13/686; B60T 7/042; B60T 13/142

(57) ABSTRACT

An electrohydraulic motor vehicle brake system comprises a master cylinder, an electromechanical actuator for actuating a piston accommodated in the master cylinder, an accommodating device for at least temporarily accommodating hydraulic fluid from the master cylinder, and a set of electrically actuatable valve arrangements. The set of valve arrangements comprises a first valve arrangement between the master cylinder and every wheel brake of the plurality of wheel brakes and a second valve arrangement between the master cylinder and the accommodating device. The system further comprises a controller or a controller system which is designed to control at least one of the first valve arrangements and the second valve arrangement in a multiplex operation.

### CROSS-REFERENCE TO RELATED APPLICATIONS

This application is a national stage of International Application No. PCT/EP2013/074926 filed Nov. 28, 2013, the disclosures of which are incorporated herein by reference in entirety, and which claimed priority to German Patent Application No. DE 10 2012 025 247.1 filed Dec. 21, 2012, the disclosures of which are incorporated herein by reference in entirety.

### BACKGROUND OF THE INVENTION

The present disclosure relates generally to the field of vehicle brake systems. Concretely, an electrohydraulic vehicle brake system with an electromechanical actuator for actuating the brake system is described.

Electromechanical actuators have already been used for some time in vehicle brake systems, for example, for realizing an electrical parking brake function (EPB). In the case of electromechanical brake systems (EMB), they replace the conventional hydraulic cylinders at the wheel brakes.

Owing to technical advances, the efficiency of the electromechanical actuators has continually increased. It was therefore considered to use such actuators also for implementing modern driving dynamics control systems. Such control systems include an antilock braking system (ABS), a traction control system (TCS) or an electronic stability program (ESP), also referred to as vehicle stability control (VSC).

WO 2006/111393 A, and corresponding U.S. Pat. No. 8,540,324 B2, both of which are incorporated by reference herein in entirety, teach an electrohydraulic brake system having a highly dynamic electromechanical actuator which performs the pressure modulation in the driving dynamics control mode. The electromechanical actuator described in WO 2006/111393 A is provided to act directly on a master cylinder of the brake system. Owing to the high dynamics of the electromechanical actuator, the hydraulic components of the brake system known from WO 2006/111393 A can be reduced to a single 2/2-way valve per wheel brake. To realize wheel-individual pressure modulations, the valves are then activated individually or in groups in multiplex operation.

However, the minimizing to only one valve per wheel brake also results in challenges, such as an undesired pressure equalization when valves are opened simultaneously. A solution based on a highly dynamic control behaviour is specified for this in WO 2010/091883 A, and corresponding U.S. Patent No. US 2012/013173 A1, both of which are incorporated by reference herein in entirety.

WO 2010/091883 A discloses an electrohydraulic brake system having a master cylinder and a tandem piston accommodated therein. The tandem piston is actuable by means of an electromechanical actuator. The electromechanical actuator comprises an electric motor arranged concentrically with respect to the tandem piston, as well as a transmission arrangement which converts a rotational movement of the electric motor into a translational movement of the piston. The transmission arrangement is composed of a ball screw drive having a ball screw nut coupled in a rotationally fixed manner to a rotor of the electric motor and a ball screw spindle acting on the tandem piston.

A further electrohydraulic brake system having an electromechanical actuator acting on a master cylinder piston is known from WO 2012/152352 A, and corresponding U.S. Patent No. US 2014/197680 A1, both of which are incorporated by reference herein in entirety. This system can operate in a regenerative mode (generator mode).

### BRIEF SUMMARY OF THE INVENTION

An electrohydraulic vehicle brake system and a method for operating the same which have an improved functionality are to be specified.

According to a first aspect, an electrohydraulic motor-vehicle brake system is provided. This brake system comprises a master cylinder, an electromechanical actuator for actuating a first piston accommodated in the master cylinder, a receiving device for at least temporarily receiving hydraulic fluid from the master cylinder, and a set of electrically activatable valve arrangements, the set of valve arrangements comprising a respective first valve arrangement between the master cylinder and each one of a plurality of wheel brakes, and a second valve arrangement between the master cylinder and the receiving device. The brake system further comprises a control unit or control unit system, which is configured to activate at least one of the first valve arrangements and the second valve arrangement in multiplex operation.

The first piston accommodated in the master cylinder can be directly or indirectly actuated by the electromechanical actuator. For example, the electromechanical actuator can be arranged for direct action on the first piston of the master cylinder. For this, it can be mechanically coupled or couplable to the first piston. The first piston can then be directly actuated by the actuator. Alternatively to this, the electromechanical actuator can cooperate with a cylinder/piston device of the brake system different from the master cylinder and the cylinder/piston device can be fluidically coupled on the outlet side to the first piston of the master cylinder (e.g. directly). A hydraulic pressure built up in the cylinder/piston device by actuation of the electromechanical actuator can then act on the first piston and hydraulically actuate the first piston in the master cylinder. In this configuration, the first piston is thus hydraulically actuated via the hydraulic pressure generated in the cylinder/piston arrangement and with the aid of the electromechanical actuator (indirect actuation).

The control unit or control unit system can be configured to operate all of the first valve arrangements and the second valve arrangement in multiplex operation. According to one implementation, in multiplex operation, the hydraulic pressures at the wheel brakes are adjusted sequentially (individually or in groups) by opening and closing the first valve arrangements. The receiving device may also be affected by the sequential hydraulic pressure adjustment.

The multiplex operation can be a time multiplex operation. Generally, in the multiplex operation, individual time slots can be preset, during which one or more valve arrangements assigned to a specific time slot can be actuated (for example by changing the switching state once or more than once from open to closed and/or vice versa). According to one realization, each of the first valve arrangements is assigned exactly one time slot. The second valve arrangement can be assigned a further independent time slot. Alternatively to this, the second valve arrangement can be assigned one or more of those time slots which are also assigned to one or more of the first valve arrangements. Thus, the second valve arrangement can be actuated synchronously with one or more of the first valve arrangements in the multiplex operation.

According to one activating concept, the second valve arrangement is always open when at least one of the first valve arrangements is open. According to a further activating concept, the second valve arrangement is always closed when at least one of the first valve arrangements is open. Still further, alternative activating concepts are, of course, also conceivable.

The receiving device can be configured in various ways. According to one implementation, the receiving device is a conventional hydraulic pressure accumulator. The hydraulic pressure accumulator can be configured, for example, as an HPA (high pressure accumulator) or as an LPA (low pressure accumulator). Furthermore, the receiving device can be configured as a receiving cylinder. A second piston can be accommodated in the receiving cylinder. The second piston can, for example, be coupled or be adapted to be coupled to a brake pedal. Furthermore, the second piston can be biased, in order, for example, to counteract a brake pedal actuation.

The control unit or control unit system can be configured to act on the second piston by activating the second valve arrangement. This acting-on can consist in displacing the second piston in the receiving cylinder in a particular direction. According to one implementation, the control unit or control unit system is configured to produce, by acting on the second piston, a pedal reaction indicating a driver-independent braking intervention. The driver-independent braking intervention can be associated with a driving dynamics control mode.

The receiving cylinder, or generally the receiving device, can be coupled via a fluid line to a simulation device for hydraulic simulation of a pedal reaction characteristic of a service braking. A third valve arrangement can be provided between the receiving device and the simulation device. In this case, the second valve arrangement and the third valve arrangement are provided downstream of the receiving device in hydraulic lines which run parallel to one another and lead respectively to the master cylinder and the simulation device.

The third valve arrangement can be used to adjust a brake pedal characteristic or to switch between different characteristics. In this connection, the third valve arrangement can have a preset or adjustable throttling function. The third valve arrangement can be used, for example, to realize a sporty by a short response travel of the brake pedal, while a comfortable can be represented by a long response travel.

A fourth valve arrangement can be provided in a fluid line between the receiving device and an unpressurised fluid reservoir. Furthermore, a fifth valve arrangement can be installed in a fluid line between the master cylinder and the unpressurised fluid reservoir.

The control unit or control unit system can be configured to adjust hydraulic pressures individually in at least one of the wheel brakes and in the receiving device in multiplex operation. In this case, the first valve arrangements can be opened and closed wheel-individually or wheel-group-individually. The second valve arrangement can be opened and closed synchronously with one or more of the first valve arrangements. The synchronicity can be implemented by a synchronous activating concept, as described above.

The first valve arrangements and the second valve arrangement can in each case comprise a single valve. At least in the case of the first valve arrangements, this valve can be a non-adjustable shut-off valve.

Furthermore, the first valve arrangements and the second valve arrangements can be provided downstream of the master cylinder in hydraulic lines which run parallel to one another and lead respectively to the wheel brakes and the receiving device. According to one implementation, no further valves are provided functionally in these hydraulic lines between the master cylinder on the one hand and the wheel brakes and the receiving device on the other hand.

The electromechanical actuator can comprise an electric motor and a transmission coupled to the electric motor. The transmission can be coupled to an actuating member acting on the first piston. As an optional feature, the electric motor and the transmission are arranged at least partially concentrically with respect to the actuating member.

According to a further aspect, an electrohydraulic motor-vehicle brake system is specified. The brake system comprises a master cylinder for hydraulic pressure generation in a “push-through” mode of the brake system, an electromechanical hydraulic pressure generator for hydraulic pressure generation in a “break-by-wire” mode (BBW mode) of the brake system, and a set of electrically activatable valve arrangements. The set of valve arrangements comprises for each one of a plurality of wheel brakes a respective first valve arrangement between the master cylinder and the hydraulic pressure generator on the one hand and the wheel brake on the other hand and a second valve arrangement between the master cylinder and the electromechanical hydraulic pressure generator. Furthermore, there is provided a control unit or a control unit system, which is configured to activate at least one of the first valve arrangements and the second valve arrangement in multiplex operation.

In the brake system according to the second aspect, the control unit or control unit system can be configured to act on a piston, accommodated in the master cylinder and coupled or couplable to a brake pedal by activating the second valve arrangement. In this case, by acting on the piston, in particular a pedal reaction indicating a driver-independent braking intervention (for example a driving dynamics control) can be produced.

The hydraulic pressure generator according to the second aspect can comprise an electric motor and a transmission coupled to the electric motor. Furthermore, a piston coupled to the transmission and accommodated in a hydraulic cylinder can be provided. The hydraulic cylinder can be fluidically coupled or couplable to the wheel brakes. In particular, the first valve arrangements can be provided between the hydraulic cylinder and the respectively assigned wheel brake.

Generally, the first valve arrangements of the brake system presented here can each comprise exactly one electromagnetic valve. The electromagnetic valve can be opened for hydraulic pressure generation or for hydraulic pressure reduction at the associated wheel brake. To maintain a generated brake pressure or to uncouple the corresponding wheel brake from a hydraulic pressure build-up, the electromagnetic valve can be closed.

In each fluid line from the master cylinder to one of the wheel brakes, besides the first valve arrangement there can be provided no further valve arrangement for driving dynamics control purposes. However, overall the brake system can comprise at least one further valve for other purposes. Such a valve is then, however, not functionally connected between the master cylinder and one of the wheel brakes.

The control unit or the control unit system can be generally configured to activate the first valve arrangements during a driver-independent braking intervention (for example a driving dynamics control procedure). The control unit or the control unit system can in this case implement at least one of the following driving dynamics control functionalities for the driver-independent braking intervention: an antilock braking system (ABS), a traction control system (TCS) and an electronic stability program (ESP, also referred to as vehicle stability control, VSC).

Furthermore there is provided an electrohydraulic motor-vehicle brake system, which comprises a master cylinder, an electromechanical actuator for hydraulic pressure generation in a BBW mode of the brake system, a simulation device for producing a pedal reaction and a valve arrangement arranged upstream of the simulation device. The simulation device is configured to receive hydraulic fluid displaced upon a brake pedal actuation in the BBW mode, and the valve arrangement is able to selectively shut off the reception of hydraulic fluid in the simulation device. The brake system further comprises a control unit or a control unit system which is configured to activate the valve arrangement in the driving dynamics control mode of the brake system, in order to limit a brake pedal travel.

The brake pedal travel can be limited in the driving dynamics control mode compared with a brake pedal travel in the case of a service braking which does not require driving dynamics control. By means of the limited brake pedal travel, the driver can be haptically informed at the brake pedal about the beginning of the driving dynamics control. According to one implementation, the brake pedal travel limitation can be dependent on a coefficient of friction of the roadway. For example, the brake pedal travel limitation could take place in a specific relationship to this coefficient of friction.

There is also provided a method for operating an electrohydraulic motor-vehicle brake system, which comprises a master cylinder, an electromechanical actuator for actuating a first piston accommodated in the master cylinder, a receiving device for at least temporarily receiving hydraulic fluid from the master cylinder, a set of electrically activatable valve arrangements, and a plurality of wheel brakes, the set of valve arrangements comprising a respective first valve arrangement between the master cylinder and each wheel brake, and a second valve arrangement between the master cylinder and the receiving device. The method comprises the step of activating at least one of the first valve arrangements and the second valve arrangement in multiplex operation.

In multiplex operation, in each case individual hydraulic pressure can be adjusted or else be adjustable in at least one of the wheel brakes and in the receiving device. The multiplex operation can take place in such a manner that, when different hydraulic pressures have to be set at a plurality of wheel brakes and in the receiving device, the valve arrangements concerned are initially all opened and then individually closed when an individual target pressure is reached. As already stated above, the multiplex operation can be based on time slots, at least one of the valve arrangements being assigned to each time slot.

When the receiving device is configured as a receiving cylinder, in which a second piston coupled to a brake pedal is provided, the second valve arrangement can be actuated in multiplex operation, in order to act (hydraulically) on the second piston. The acting on the second piston can produce a pedal reaction indicating a driver-independent braking intervention. This pedal reaction may be, for example, the typical pulsations of a driving dynamics control mode. Alternatively or additionally to this, the acting on the second piston can realize a pedal travel limitation, in order to indicate a roadway coefficient of friction via the pedal travel.

Also specified is a method for operating an electrohydraulic vehicle brake system, which comprises a master cylinder for hydraulic pressure generation in a “push-through” mode of the brake system, an electromechanical hydraulic pressure generator for hydraulic pressure generation in a BBW mode of the brake system, a set of electrically activatable valve arrangements and a plurality of wheel brakes, the set of valve arrangements comprising per wheel brake a respective first valve arrangement between the master cylinder and the hydraulic pressure generator on the one hand and the wheel brake on the other hand and a second valve arrangement between the master cylinder and the electromechanical hydraulic pressure generator. The method comprises the step of activating at least one of the first valve arrangements and the second valve arrangement in multiplex operation.

According to the second method aspect, by activating the second valve arrangement, a piston, accommodated in the master cylinder and coupled or couplable to a brake pedal, can be acted on. By acting on the piston, a pedal reaction indicating a driver-independent braking intervention can be produced. Alternatively or additionally to this, the acting on the piston can realise a pedal travel limitation, in order to indicate a roadway coefficient of friction via the pedal travel.

In all the aspects presented here, an actuation of the first valve arrangements can be prioritised over an actuation of the second valve arrangement in the multiplex operation. If, for example, it can be detected that the available hydraulic fluid volume might not be sufficient for a particular process, the second valve arrangement can remain closed in order to prioritise the first valve arrangements.

Further specified is a method for operating an electrohydraulic motor-vehicle brake system, which comprises a master cylinder, an electromechanical actuator for hydraulic pressure generation in a BBW mode of the brake system, a simulation device for producing a pedal reaction and a valve arrangement arranged upstream of the simulation device. The simulation device is configured to receive hydraulic fluid displaced upon a brake pedal actuation in the BBW mode, the valve arrangement being able to selectively shut off the reception of hydraulic fluid in the simulation device. The operating method comprises the step of activating the valve arrangement in a driving dynamics control mode of the brake system, in order to limit a brake pedal travel.

Also provided is a computer program product with program code means for carrying out the method presented here when the computer program product runs on at least one processor. Further specified is a motor-vehicle control unit or control unit system, which comprises the computer program product.

According to a first variant, in the brake system presented here, the electromechanical actuator is configured to actuate the master cylinder piston in the context of a brake force boosting. The brake force to be boosted can in this case be exerted on the piston by means of the mechanical actuator. According to another variant, the electromechanical actuator is configured to actuate the piston for brake force generation. This variant can be used, for example, in the context of a BBW operation, in which the brake pedal is (normally) mechanically decoupled from the master cylinder piston. In the case of a brake system designed for BBW operation, the mechanical actuator is used to actuate the piston, for instance, in the event of failure of a BBW component (i.e. in the “push-through” mode or in the event of an emergency braking).

Depending on the configuration of the vehicle brake system, the selective decoupling of the brake pedal from the master cylinder piston by means of a decoupling device can occur for different purposes. In the case of a brake system designed according to the BBW principle, apart from an emergency braking mode (in which the brake pedal is coupled to the master cylinder piston via the mechanical actuator), permanent decoupling can be provided. In the case of a regenerative brake system, such a decoupling can take place at least in the context of a regenerative braking mode (generator mode). In other brake systems, the decoupling device and the simulation device can also be completely omitted.

To drive the electromechanical actuator and optional further components of the vehicle brake system, the brake system can have suitable drive devices. These drive devices can comprise electrical, electronic or program-controlled assemblies and combinations thereof. For example, the drive devices can be provided in a common control unit or in a system comprising separate control units (electronic control units, ECUs).

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a first embodiment of an electrohydraulic vehicle brake system;

FIG. 2 shows a second embodiment of an electrohydraulic vehicle brake system;

FIG. 3 shows a third embodiment of an electrohydraulic vehicle brake system;

FIGS. 4A-4C show schematic diagrams illustrating embodiments of the operation of the valve arrangements.

### DETAILED DESCRIPTION OF THE INVENTION

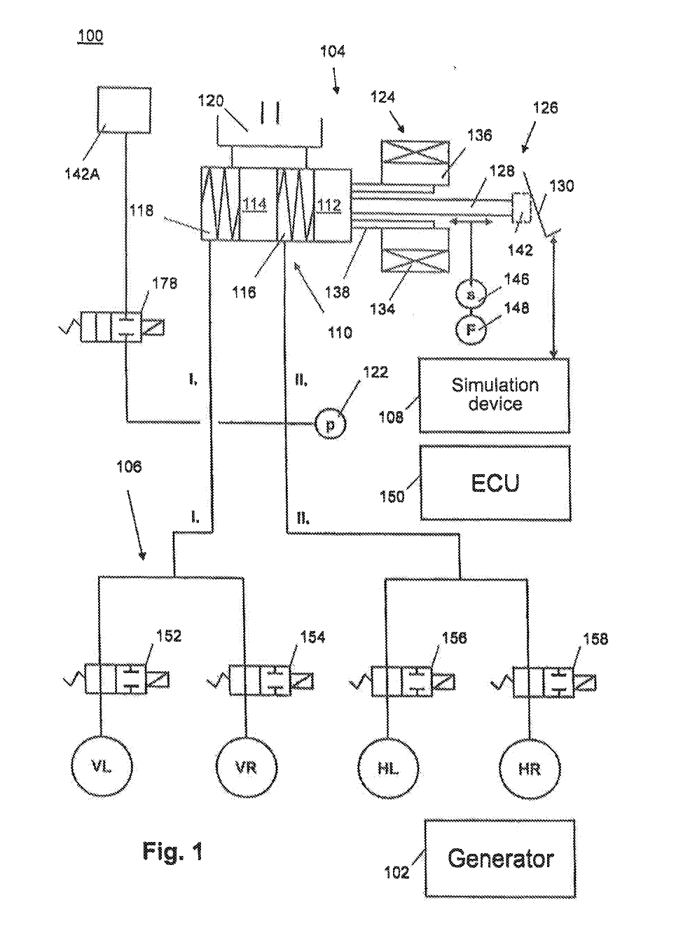

FIG. 1 shows a first embodiment of a hydraulic vehicle brake system 100, which is based on the brake-by-wire (BBW) principle. The brake system 100 may optionally (e.g. in the case of hybrid vehicles) be operated in a regenerative mode. For this purpose, there is provided an electrical machine 102 which provides a generator functionality and can be selectively connected to wheels and an energy store, e.g. a battery (not shown).

As illustrated in FIG. 1, the brake system 100 comprises a master cylinder assembly 104 which can be mounted on a vehicle front bulkhead. A hydraulic control unit (HCU) 106 of the brake system 100 is functionally arranged between the master cylinder assembly 104 and four wheel brakes VL, VR, HL and HR of the vehicle. The HCU 106 is configured as an integrated assembly and comprises a large number of hydraulic individual components, as well as several fluid inlets and fluid outlets. Furthermore, a merely schematically represented simulation device 108 for providing a pedal reaction in service braking mode is provided. The simulation device 108 can be based on a mechanical or hydraulic principle. In the latter case, the simulation device 108 can be connected to the HCU 106.

The master cylinder assembly 104 has a master cylinder 110 with a piston 140 accommodated displaceably therein. The piston is configured in the embodiment as a tandem piston with a primary piston 112 and a secondary piston 114 and defines in the master cylinder 110 two hydraulic chambers 116, 118 separated from one another. The two hydraulic chambers 116, 118 of the master cylinder 110 are connected to an unpressurised hydraulic fluid reservoir 120 via a respective connection in order to supply them with hydraulic fluid. Each of the two hydraulic chambers 116, 118 is further coupled to the HCU 106 and defines a respective brake circuit I. and II. In the embodiment, there is provided for the brake circuit I. a hydraulic pressure sensor 122, which could also be integrated into the HCU 106.

The master cylinder assembly 104 further comprises an electromechanical actuator 124 as well as a mechanical actuator 126. Both the electromechanical actuator 124 and the mechanical actuator 126 enable an actuation of the master cylinder piston and for this purpose act on an input-side end face of this piston, to be more precise of the primary piston 112. The actuators 124, 126 are configured in such a manner as to be able to actuate the master cylinder piston independently of one another (and separately or jointly).

In the variant of the master cylinder assembly 104 shown in FIG. 1, the electromechanical actuator 124 is arranged in such a manner that it can act directly on the piston (to be more precise on the primary piston 112) of the master cylinder 110 to build up a hydraulic pressure at the wheel brakes. In other words, the piston 112 of the master cylinder 110 is mechanically actuated directly by the electromechanical actuator 124.

In an alternative configuration of the master cylinder assembly 104, the piston of the master cylinder 110 can be hydraulically actuated (not shown in FIG. 1) with the aid of the electromechanical actuator 124. In this case, the master cylinder 110 can be fluidically coupled to a further cylinder/piston device cooperating with the electromechanical actuator 124. Concretely, the cylinder/piston device coupled to the electromechanical actuator 124 can be fluidically coupled on the outlet side to the primary piston 112 of the master cylinder 110 in such a manner that a hydraulic pressure generated in the cylinder/piston device acts directly on the primary piston 112 and thus leads to an actuation of the primary piston 112 in the master cylinder 110. In one realisation, the primary piston 112 can then, owing to the hydraulic pressure acting, be displaced in the master cylinder 110 to such an extent (displacement to the left in FIG. 1) until the hydraulic pressure generated in the master cylinder chambers 116, 118 corresponds to the hydraulic pressure generated in the additional cylinder/piston device.

The mechanical actuator 126 has a force transmission element 128 which is configured in the form of a rod and is able to act directly on the input-side end face of the primary piston 112. As shown in FIG. 1, the force transmission element 128 is coupled to a brake pedal 130. It will be understood that the mechanical actuator 126 may comprise further components which are functionally arranged between the brake pedal 130 and the master cylinder 110. Such further components can be both of a mechanical and a hydraulic nature. In the latter case, the actuator 126 is configured as a hydraulic-mechanical actuator 126.

The electromechanical actuator 124 has an electric motor 134 and a transmission 136, 138 downstream of the electric motor 134 on the drive side. In the embodiment, the transmission is an arrangement composed of a rotatably mounted nut 136 and a spindle 138 in engagement with the nut 136 (e.g. via rolling bodies such as balls) and movable in the axial direction. In other embodiments, toothed rack transmissions or other transmission types can be used.

In the present embodiment, the electric motor 134 has a cylindrical design and extends concentrically with respect to the force transmission element 128 of the mechanical actuator 126. To be more precise, the electric motor 134 is arranged radially outside with respect to the force transmission element 128. A rotor (not shown) of the electric motor 134 is coupled in a rotationally fixed manner to the transmission nut 136, in order to set the latter in rotation. A rotary movement of the nut 136 is transmitted to the spindle 138 in such a manner that an axial displacement of the spindle 138 results. In this procedure, the end side, on the left in FIG. 1, of the spindle 138 can come into abutment (optionally via an intermediate member) with the end side, on the right in FIG. 1, of the primary piston 112 and consequently displace the primary piston 112 (together with the secondary piston 114) to the left in FIG. 1. Furthermore, the piston arrangement 112, 114 can also be displaced to the left in FIG. 1 by the force transmission element 128, extending through the spindle 138 (configured as a hollow body), of the mechanical actuator 126. A displacement of the piston arrangement 112, 114 to the right in FIG. 1 is brought about by means of the hydraulic pressure prevailing in the hydraulic chambers 116, 118 (upon release of the brake pedal 130 and optionally upon motive displacement of the spindle 138 to the right).

As shown in FIG. 1, a decoupling device 142 is functionally provided between the brake pedal 130 and the force transmission element 128. The decoupling device 142 enables a selective decoupling of the brake pedal 130 from the piston arrangement 112, 114 in the master cylinder 110 (e.g. by interruption of the force transmission path). In the following, the functioning of the decoupling device 142 and of the simulation device 108 is explained in more detail. In this connection, it should be pointed out that the brake system 100 shown in FIG. 1 is based on the principle of brake-by-wire (BBW). This means that, in the context of a normal service braking, both the decoupling device 142 and the simulation device 108 are activated. Accordingly, the brake pedal 130 is decoupled from the force transmission element 128 (and thus from the piston arrangement 112, 114 in the master cylinder 110), and an actuation of the piston arrangement 112, 114 can take place exclusively via the electromechanical actuator 124. In this case, the usual pedal reaction is provided by the simulation device 108 coupled to the brake pedal 130.

In the context of the service braking, the electromechanical actuator 124 thus performs the brake force generating function. In this case, a brake force required by depressing the brake pedal 130 is generated by the fact that the spindle 138 is displaced to the left in FIG. 1 by means of the electric motor 134 and as a result the primary piston 112 and the secondary piston 114 of the master cylinder 110 are also moved to the left. In this way, hydraulic fluid is conveyed from the hydraulic chambers 116, 118 via the HCU 106 to the wheel brakes VL, VR, HL and HR.

The level of the brake force, resulting therefrom, of the wheel brakes VL, VR, HL and HR is set in dependence on a sensor-detected brake pedal actuation. For this purpose, a travel sensor 146 and a force sensor 148 are provided, the output signals of which are evaluated by a control unit (electronic control unit, ECU) 150 driving the electric motor 134. The travel sensor 146 detects an actuation travel associated with an actuation of the brake pedal 130, while the force sensor 148 detects an actuation force associated therewith. A drive signal for the electric motor 134 is generated by the control unit 150 in dependence on the output signals of the sensors 146, 148 (and optionally of the pressure sensor 122).

Since the procedures in the case of a service braking have been explained in more detail, the emergency braking mode will now be briefly outlined. The emergency braking mode is, for example, the consequence of the failure of the vehicle battery or of a component of the electromechanical actuator 124. A deactivation of the decoupling device 142 (and of the simulation device 108) in the emergency braking mode enables a direct coupling of the brake pedal 130 to the master cylinder 110, namely via the force transmission element 128 (“push-through” mode). The emergency braking is initiated by depressing the brake pedal 130. The brake pedal actuation is then transmitted via the force transmission element 128 to the master cylinder 110. Consequently, the piston arrangement 112, 114 is displaced to the left in FIG. 1. As a result, for the brake force generation, hydraulic fluid is conveyed from the hydraulic chambers 116, 118 of the master cylinder 110, via the HCU 106, to the wheel brakes VL, VR, HL and HR.

In the case of the embodiment according to FIG. 1, the HCU 106 comprises four valves 152, 154, 156, 158 between the master cylinder 110 and the wheel brakes VL, VR, HL, HR. In the case of this embodiment of the HCU 106, recourse may thus be had to the valve arrangement (and the corresponding activation) known from WO 2010/091883 A or WO 2011/141158 A (cf. FIG. 15).

The hydraulic pressure modulation in the driving dynamics control mode takes place by means of the electromechanical actuator 124. In other words, the electromechanical actuator 124 is activated not only for brake force generation in the context of a service braking, but also, for example, for the purpose of driving dynamics control (thus e.g. in the ABS and/or TCS and/or ESP control mode). Together with the activation of the electromechanical actuator 124, a wheel-individual or wheel-group-individual activation of the valves 152, 154, 156, 158 takes place in a time multiplex operation. For the multiplex operation, each of the valves 152, 154, 156, 158 can then be assigned its own time slot in which the valve concerned can be activated once or more than once (e.g. opened and/or closed). In the implementation shown in FIG. 1, no further valves for driving dynamics control purposes are present between the wheel brakes VL, VR, HL and HR and the master cylinder 110.

In multiplex operation, for example, initially a plurality of or all of the valves 152, 154, 156, 158 can be opened and simultaneously a hydraulic pressure can be built up at a plurality of or all of the assigned wheel brakes VL, VR, HL and HR by means of the electromechanical actuator 124. When a wheel-individual target pressure is reached, the corresponding valve 152, 154, 156, 158 then closes, while one or more further valves 152, 154, 156, 158 still remain open until the respective target pressure is reached at those too. In multiplex operation, the four valves 152, 154, 156, 158 are therefore opened and closed, time-slot-synchronously, individually per wheel or wheel group in dependence on the respective target pressure.

According to one embodiment, the valves 152, 154, 156, 158 are realised as 2/2-way valves and configured, for example, as non-adjustable shut-off valves. In this case, therefore, no opening cross-section can be adjusted, as would be the case for example with proportional valves. In another embodiment, the valves 152, 154, 156, 158 are realized as proportional valves with adjustable opening cross-section.

As illustrated in FIG. 1, the brake system 100 comprises, in addition to the multiplex valves 152, 154, 156, 158, at least one second valve arrangement 178, which is provided between the master cylinder 110 and a receiving device 142A. In the embodiment, the valve arrangement 178 is arranged between the hydraulic chamber 116 of the master cylinder 110 on the one hand and the receiving device 142A on the other hand. A similar valve arrangement could be provided additionally or alternatively to this between the second hydraulic chamber 118 of the master cylinder 110 and an additional receiving device (not shown) or the existing receiving device 142A. Furthermore, the valve arrangement 178 could also lead into a receiving device (not shown in FIG. 1) comprised by the decoupling device 142, instead of into the separate receiving device 142A.

In the embodiment, the valve arrangement 178 comprises a single valve which can be configured as an adjustable or non-adjustable shut-off valve and integrated into the HCU 106. The receiving device 142A can be a pressure accumulator (for example a diaphragm-based LPA or HPA). The receiving device 142A could also be configured as a cylinder/piston arrangement.

All five valves 152, 154, 156, 158, 178 are activatable by the control unit 150 in multiplex operation. Such an activation can take place for different purposes, for example for temporary storage of hydraulic fluid in the receiving device 142A. The receiving device 142A therefore functions as an “additional” hydraulic fluid consumer besides the four wheel brakes VL, VR, HL and HR. In other words, the receiving device 142A “simulates” a “fifth” wheel. According to this point of view, the “five” wheels are controllable wheel-individually or wheel-group-individually in multiplex operation. In a time-slot-based multiplex operation, the valve arrangement 178 could be assigned its own time slot. In this case, an activating cycle of the control unit 150 would comprise five time slots (one time slot for each of the five valves 152, 154, 156, 158, 178). Alternatively to this, the valve arrangement 178 could be assigned one or more of the time slots which are provided for the multiplex valves 152, 154, 156, 158. In this case, an activating cycle comprises four time slots.

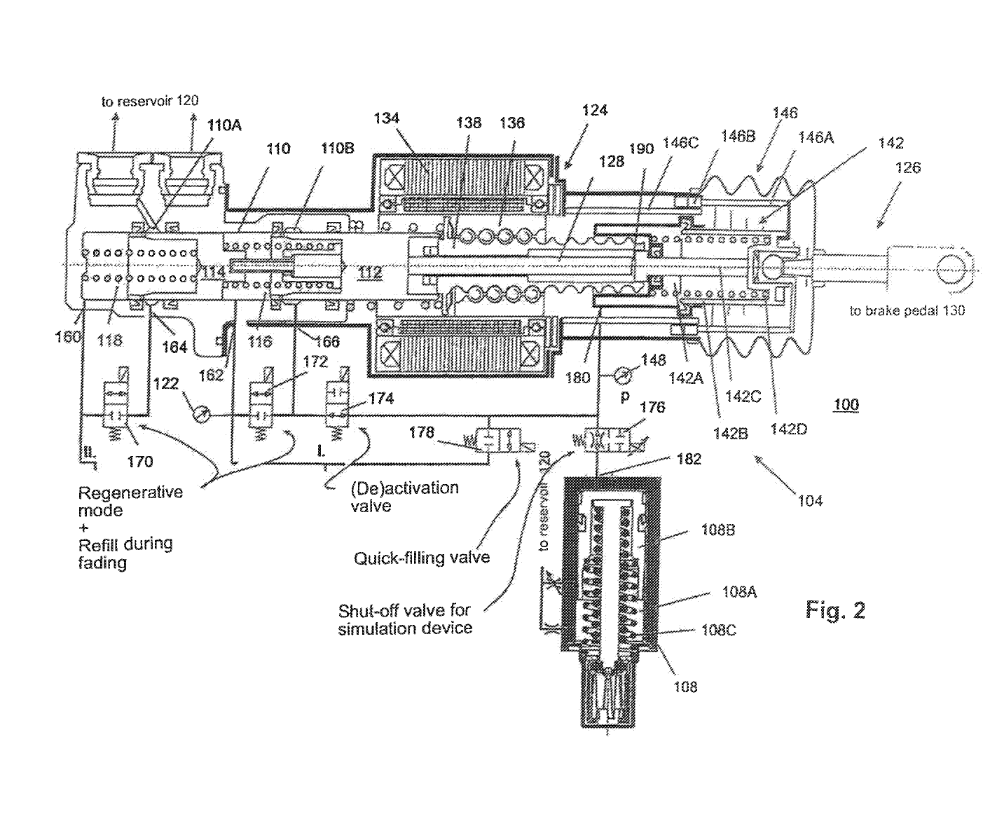

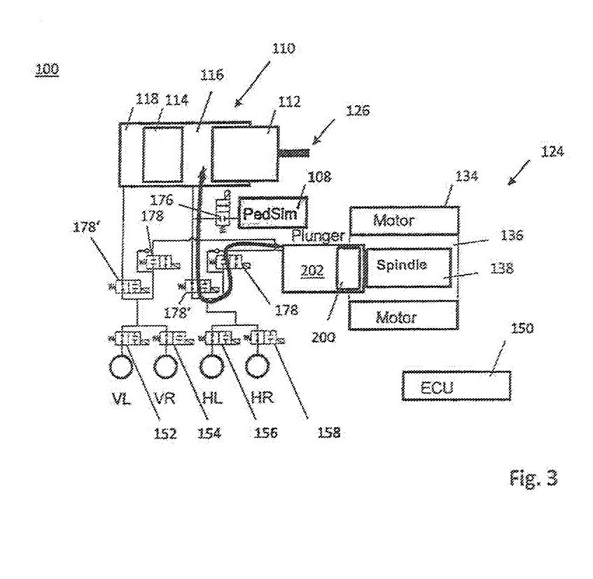

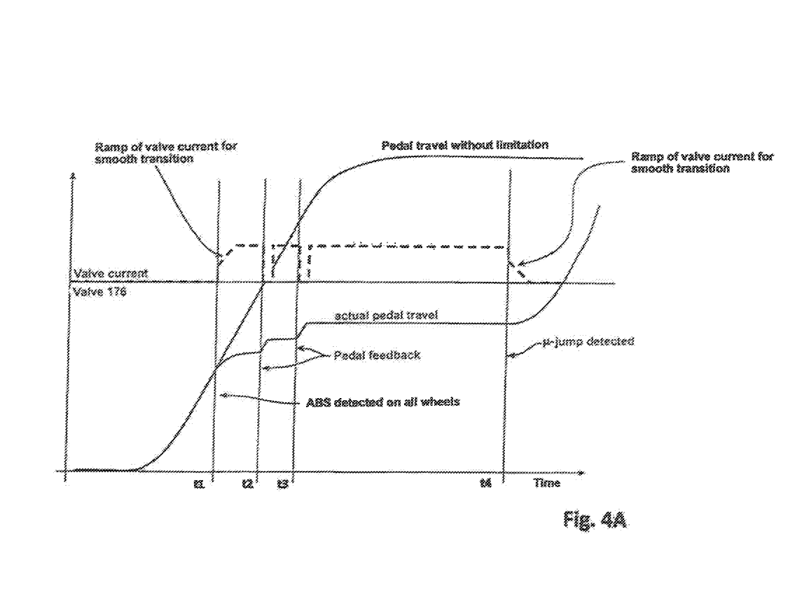

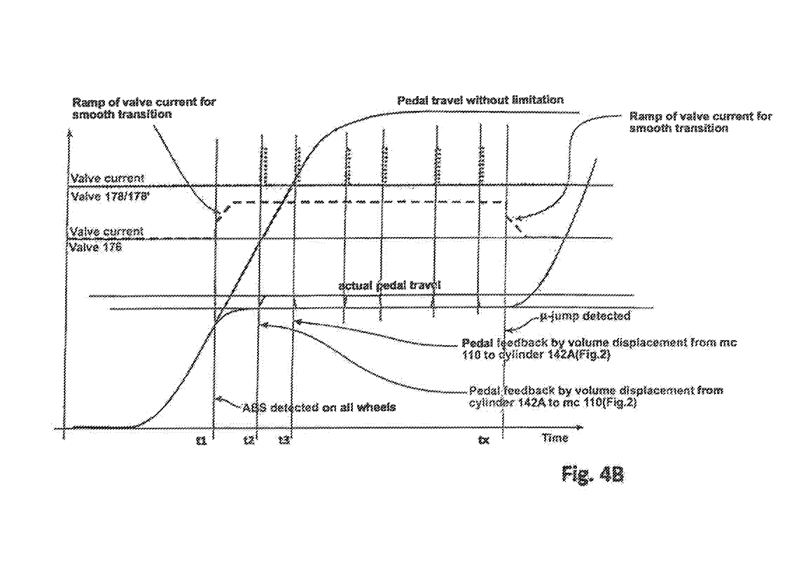

FIG. 2 shows a more detailed embodiment of a vehicle brake system 100, which is based on the operating principle explained in connection with the schematic embodiment of FIG. 1. Identical or similar elements have been provided with the same reference symbols as FIG. 1, and their explanation is dispensed with in the following. For the sake of clarity, the ECU, the wheel brakes, the four valve units of the HCU (multiplex valves 152, 154, 156, 158 in FIG. 1) assigned to the wheel brakes, and the generator for the regenerative braking mode have not been shown.

The vehicle brake system 100 illustrated in FIG. 2 also comprises two brake circuits I. and II., two hydraulic chambers 116, 118 of a master cylinder 110 being respectively assigned again to exactly one brake circuit I., II. The master cylinder 100 has two connections per brake circuit I., II. The two hydraulic chambers 116, 118 here lead to a respective first connection 160, 162, via which hydraulic fluid can be conveyed from the respective chamber 116, 118 into the assigned brake circuit I., II. Furthermore, each of the brake circuits I. and II. can be connected via a respective second connection 164, 166, which leads into a corresponding annular chamber 110A, 110B in the master cylinder 110, to the unpressurised hydraulic fluid reservoir (reference symbol 120 in FIG. 1) not shown in FIG. 2.

Between the respective first connection 160, 162 and the respective second connection 164, 166 of the master cylinder 110 there is provided a respective valve 170, 172 which is realized as a 2/2-way valve in the embodiment. The first and second connections 160, 162, 164, 166 can be selectively connected to one another by means of the valves 170, 172. This corresponds to a “hydraulic short circuit” between the master cylinder 110 on the one hand and, on the other hand, the unpressurised hydraulic fluid reservoir (which is then connected to the hydraulic chambers 116, 118 via the annular chambers 110A, 110B). In this state, the pistons 112, 114 in the master cylinder 110 can be displaced by the electromechanical actuator 124 or the mechanical actuator 126 in a manner substantially free from resistance (“free travel clearance”). The two valves 170, 172 thus enable, for example, a regenerative braking mode (generator mode). Here, the hydraulic fluid displaced from the hydraulic chambers 116, 118 upon a conveying movement in the master cylinder 110 is then led not to the wheel brakes, but to the unpressurised hydraulic fluid reservoir, without a hydraulic pressure build-up (usually undesired in the regenerative braking mode) occurring at the wheel brakes. A braking effect is then obtained in the regenerative braking mode by the generator (cf. reference symbol 102 in FIG. 1).

It should be pointed out that the regenerative braking mode can be implemented by axle. In the case of an axle-based brake circuit configuration, therefore, one of the two valves 170, 172 can be closed and the other open in the regenerative braking mode.

The two valves 170, 172 furthermore enable the reduction of hydraulic pressure at the wheel brakes. Such a pressure reduction may be desired in the event of failure (e.g. blocking) of the electromechanical actuator 124 or in the driving dynamics control mode, in order to avoid a return stroke of the electromechanical actuator 124 (e.g. in order to avoid a reaction on the brake pedal). For the pressure reduction also, the two valves 170, 172 are transferred into their open position, whereby hydraulic fluid can flow out of the wheel brakes, via the annular chambers 110A, 110B in the master cylinder 110, back into the hydraulic fluid reservoir.

Finally, the valves 170, 172 also enable a refilling of the hydraulic chambers 116, 118 as well. Such a refilling may be required during a braking procedure in progress (e.g. owing to so-called brake “fading”). For refilling, the wheel brakes are fluidically separated from the hydraulic chambers 116, 118 via assigned valves of the HCU (not shown in FIG. 2). The hydraulic pressure prevailing at the wheel brakes is thus “locked in”. Thereupon, the valves 170, 172 are opened. Upon a subsequent return stroke of the pistons 112, 114 provided in the master cylinder 110 (to the right in FIG. 2), hydraulic fluid is then sucked out of the unpressurised reservoir into the chambers 116, 118. Finally, the valves 170, 172 can be closed again and the hydraulic connections to the wheel brakes opened again. Upon a subsequent conveying stroke of the pistons 112, 114 (to the left in FIG. 2), the previously “locked in” hydraulic pressure can then be further increased.

As shown in FIG. 2, in the present embodiment both a simulation device 108 and a decoupling device 142 are based on a hydraulic principle. Both devices 108, 142 comprise a respective cylinder 108A, 142A for receiving hydraulic fluid and a piston 108B, 142B accommodated in the respective cylinder 108A, 142A. The piston 142B of the decoupling device 142 is mechanically coupled to a brake pedal (cf. reference symbol 130 in FIG. 1) not shown in FIG. 2. Furthermore, the piston 142B has an extension 142C extending in the axial direction through the cylinder 142A. The piston extension 142C runs coaxially with respect to a force transmission element 128 for the primary piston 112 and is arranged upstream of the latter in the actuating direction of the brake pedal.

Each of the two pistons 108B, 142B is biased into its starting position by an elastic element 108C, 142D (here in each case a helical spring). The characteristic of the elastic element 108C of the simulation device 108 defines here the desired pedal reaction.

As further shown in FIG. 2, the vehicle brake system 100 in the present embodiment comprises three further valves 174, 176, 178, which are realized here as 2/2-way valves. It will be understood that individual ones of or all of these three valves 174, 176, 178 may be omitted in other embodiments in which the corresponding functionalities are not required. Furthermore, it will be understood that all of these valves may be part of a single HCU block (cf. reference symbol 106 in FIG. 1). The first valve 174 is provided, on the one hand, between the decoupling device 142 (via a connection 180 provided in the cylinder 142A) and the simulation device 108 (via a connection 182 provided in the cylinder 108A) and, on the other hand, the unpressurised hydraulic fluid reservoir (via the connection 166 of the master cylinder 110). Arranged upstream of the connection 182 of the cylinder 108A is the second valve 176, which has a throttling characteristic in its let-through position. The third valve 178, finally, is provided between the hydraulic chamber 116 (via the connection 116) and the brake circuit I., on the one hand, and the cylinder 142A of the decoupling device 142 (via the connection 180), on the other hand.

The first valve 174 enables a selective activation and deactivation of the decoupling device 142 (and indirectly also of the simulation device 108). If the valve 174 is in its open position, the cylinder 142A of the decoupling device 142 is hydraulically connected to the unpressurised hydraulic reservoir. In this position, the decoupling device 142 is deactivated in accordance with the emergency braking mode. Furthermore, the simulation device 108 is also deactivated.

The opening of the valve 174 has the effect that, upon displacement of the piston 142B (as a result of an actuation of the brake pedal), the hydraulic fluid received in the cylinder 142A can be conveyed into the unpressurised hydraulic fluid reservoir in a manner largely free from resistance. This procedure is substantially independent of the position of the valve 176, since the latter also has a significant throttling effect in its open position. Thus, in the open position of the valve 174, the simulation device 108 is also indirectly deactivated.

Upon a brake pedal actuation in the open state of the valve 174, the piston extension 142C overcomes a gap 190 towards the force transmission element 128 and consequently comes into abutment against the force transmission element 128. After the gap 190 has been overcome, the force transmission element 128 is taken along by the displacement of the piston extension 142C and thereupon actuates the primary piston 112 (and—indirectly—the secondary piston 114) in the brake master cylinder 110. This corresponds to the direct coupling, already explained in connection with FIG. 1, of brake pedal and master cylinder piston for the hydraulic pressure build-up in the brake circuits I., II. in the emergency braking mode.

By contrast, when the valve 174 is closed (and the valve 178 is closed), the decoupling device 142 is activated. This corresponds to the service braking mode. In this case, upon an actuation of the brake pedal, hydraulic fluid is conveyed from the cylinder 142A into the cylinder 108A of the simulation device 108. In this way, the simulator piston 108B is displaced against the counterforce provided by the elastic element 108C, so that the usual pedal reaction arises. Simultaneously, the gap 190 between the piston extension 142C and the force transmission element 128 is further maintained. As a result, the brake pedal is mechanically decoupled from the master cylinder.

In the present embodiment, the maintaining of the gap 190 takes place as a result of the fact that the primary piston 112 is moved, by means of the electromechanical actuator 124, at least as quickly to the left in FIG. 2 as the piston 142B is moved to the left owing to the brake pedal actuation. Since the force transmission element 128 is coupled mechanically or otherwise (e.g. magnetically) to the primary piston 112, the force transmission element 128 moves together with the primary piston 112 upon actuation of the latter by means of the transmission spindle 138. This carrying-along of the force transmission element 128 allows the gap 190 to be maintained.

The maintaining of the gap 190 in the service braking mode requires precise detection of the distance traveled by the piston 142B (and thus of the pedal travel). For this purpose, a travel sensor 146 based on a magnetic principle is provided. The travel sensor 146 comprises a plunger 146A which is rigidly coupled to the piston 142B and to the end of which is attached a magnetic element 146B. The movement of the magnetic element 146B (i.e. the distance traveled by the plunger 146B and piston 142B) is detected by means of a Hall sensor 146C. An output signal of the Hall sensor 146C is evaluated by a control unit (cf. reference symbol 150 in FIG. 1) not shown in FIG. 2. Based on this evaluation, the electromechanical actuator 124 can then be activated.

Now to the second valve 176, which is arranged upstream of the simulation device 108 and can be omitted in some embodiments. This valve 176 has a preset or adjustable throttling function. By means of the adjustable throttling function, for example a hysteresis or other characteristic for the pedal reaction can be obtained. In this way, for example a driver may be permitted to switch between different brake pedal characteristics. A short response travel of the brake pedal can simulate a sporty here, while a comfortable can be represented by a long response travel. The corresponding switching for the brake pedal can be coupled with another switching, for example for a chassis damping.

Furthermore, by selective closing of the valve 176, the movement of the piston 142B (when the valves 174, 178 are closed) and thus the brake pedal travel can be limited.

The third valve 178 enables in its open position the conveying of hydraulic fluid from the piston 142A into the brake circuit I. or the hydraulic chamber 116 of the master cylinder 110 and vice versa. A conveying of fluid from the piston 142A into the brake circuit I. enables, for example, a rapid braking (e.g. before the beginning of the conveying action of the electromechanical actuator 124), the valve 178 being immediately closed again. Furthermore, when the valve 178 is open, a hydraulic reaction (e.g. of a pressure modulation generated by means of the electromechanical actuator 124 in the driving dynamics control mode) on the brake pedal via the piston 142B can be obtained.

In a hydraulic line leading to the connection 180 of the cylinder 142A, there is provided a pressure sensor 148 whose output signal allows a conclusion to be drawn about the actuating force on the brake pedal. The output signal of this pressure sensor 148 is evaluated by a control unit (not shown in FIG. 2). Based on this evaluation, an activation of one or more of the valves 170, 172, 174, 176, 178 for realizing the above-described functionalities can then take place. Furthermore, the electromechanical actuator 124 can be activated based on this evaluation.

In the brake system 100 shown in FIG. 2, the HCU 106 shown in FIG. 1 can be used. In one embodiment, for the brake system 100 shown in FIG. 2, the multiplex arrangement according to FIG. 1 (with a total of four valves in addition to the valves illustrated in FIG. 2) can thus be used.

In the embodiment shown in FIG. 2, the multiplex operation includes, besides the four valves (cf. reference symbols 152, 154, 156, 158 in FIG. 1) assigned to the four wheel brakes, additionally the valve 178. According to FIG. 2, the valve 178 is provided between the hydraulic chamber 116 in the master cylinder 110 on the one hand and the cylinder 142A on the other hand. In the present embodiment, this arrangement of the valve 178 enables a haptic feedback to be given to the driver at the brake pedal by means of the electromechanical actuator 124. In this way, it is possible to compensate for a limitation of the brake system 100 based on the BBW principle, namely the lack of feedback at the brake pedal in the case of a driving dynamics control intervention (for example of ABS pulsations). In conventional BBW brake systems, the driver receives no feedback any more at the brake pedal decoupled from the master cylinder that a driving dynamics control has begun (for example because there is a roadway surface with a low coefficient of friction).

Therefore, according to the present embodiment, the (already present) valve 178 is activated in multiplex operation synchronously with the four multiplex valves assigned to the wheel brake. Thus, hydraulic pressure pulsations which are generated by means of the electromechanical actuator 124 and indicate a driving dynamics control mode can be transmitted into the cylinder 142A by complete or partial opening of the valve 178. The hydraulic pressure pulsations in the cylinder 142A in turn are haptically perceived by the driver when the brake pedal is partially or completely depressed.

Additionally or alternatively to this, by choosing a suitable instant for the closure of all three valves 174, 176, 178 assigned to the cylinder 142A, it is possible to achieve a targeted pedal travel limitation which reflects the coefficient of friction of the roadway via the length of the pedal travel. For, if the three valves 174, 176, 178 are closed, no more hydraulic fluid can escape from the cylinder 142A, which corresponds to a limitation of the pedal travel. For pedal travel limitation, therefore, the valve 176 assigned to the simulation device 108 can therefore also be closed (optionally synchronously with the valve 178). Generally, the valve 176 can be closed in particular when the valve 178 is opened or when, with the valve 178 closed—as described above—a pedal travel limitation is desired.

Advantageously, in multiplex operation, depending on the actuating direction of the pistons 112, 114 accommodated in the master cylinder 110, hydraulic fluid can be both conveyed into and withdrawn from the cylinder 142A (the same applies of course in the embodiment according to FIG. 1). This means that a brake pedal in the context of multiplex operation can be both moved back and moved forwards again by means of the electromechanical actuator 124. The pedal travel in each direction is realized by the respective volume displacement from and into the master cylinder 110.

Overall, various activation concepts are conceivable for the four multiplex valves assigned to the wheel brakes and for the further valve 178 (and also of the valve 176 arranged the simulation device 108). If, for example in the context of an active brake pedal actuation by the driver, it is detected at a specific instant that one or more of the wheels require a driving dynamics control (for example an ABS control), firstly the valve 176 to the simulation device 108 is closed for the pedal travel limitation (i.e. in order to indicate the low coefficient of friction of the roadway via the length of the pedal travel). The valves 174 and 178 are in this case likewise in a closed state.

In the context of the driving dynamics control, the multiplex valve at the wheel brake of each wheel concerned is now opened once or more than once (for example according to pressure build-up, pressure maintaining, and pressure reduction phases). In order to give the driver haptic feedback regarding the driving dynamics control, the valve 178 is also actuated in the course of the multiplex operation, i.e. for example repeatedly opened and closed. In this way, hydraulic pressure changes in the cylinder 142A which bring about the ABS-characteristic, pulsating pedal reaction can be obtained.

With regard to multiplex operation, various activating scenarios for the valve 178 are conceivable. According to a first variant, the valve 178 is opened or closed synchronously with one or more of the multiplex valves assigned to the wheel brakes (in particular those valves affected by the driving dynamics control). Alternatively to this, the multiplex valves assigned to the wheel brakes and the valve 178 can also be sequentially activated. According to each of these activating scenarios, a hydraulic feedthrough arises between the master cylinder 110 and the cylinder 142A when the valve 178 is open. A corresponding displacement of the master cylinder pistons 112, 114 by means of the electromechanical actuator 124 therefore results in a hydraulic reaction in the cylinder 142A and thus at the brake pedal. Via suitable activating strategies for the electromechanical actuator 124, it is thus possible to influence not only the intensity of the pedal movements; the time profile and the frequency of the pedal feedback to the driver can also be influenced by software control.

It may be desired not to allow any change in the absolute (total) pedal travel, despite the described reactions on the brake pedal. For this reason, to achieve a desired pedal movement, exactly the same hydraulic fluid volume can be conveyed into the cylinder 142A as is later let back into the master cylinder 110 again. The corresponding conveying volumes can be adjusted in a targeted manner by suitable activation of the electromechanical actuator 124.

FIG. 3 shows a further embodiment of a brake system 100. Corresponding or comparable elements to those in the embodiments according to FIGS. 1 and 2 are again designated by the same reference symbols. In a departure from the embodiments of FIGS. 1 and 2, the electromechanical actuator 124 in the embodiment according to FIG. 3 does not act on the primary piston 112 in the master cylinder 110. Rather, the electromechanical actuator 124 acts on a piston 200 which is accommodated in a separate cylinder 202 and is fluidically couplable to the wheel brakes VL, VR, HL and HR. The piston 200 is a plunger piston.

The brake system 100 according to FIG. 3 is also based on the BBW principle. Therefore, normally, i.e. in BBW mode, the master cylinder 110 is fluidically decoupled from the wheel brakes VL, VR, HL and HR. For this purpose, there are provided two shut-off valves 178′ which are respectively situated in the hydraulic line between one of the hydraulic chambers 116, 118 on the one hand and the wheel brakes VL, VR, HL and HR on the other hand.

The valves 178′ are opened only in a “push-through” mode of the brake system 100. In this mode, hydraulic fluid can be displaced from the chambers 116, 118 to the wheel brakes VL, VR, HL and HR (the multiplex valves 152, 154, 156, 158 are then open) by means of a mechanical actuator 126 which is coupled to a brake pedal (not shown in FIG. 3). In the conventional BBW principle, by contrast, the hydraulic pressure is built up at the wheel brakes VL, VR, HL and HR by means of the electromechanical actuator 124 and displacement of the plunger piston 200 with the valves 178′ closed. For this purpose, valves 178 between the cylinder 202, on the one hand, and the wheel brakes VL, VR, HL and HR, on the other hand, are to be opened.

In the present embodiment, the multiplex operation includes, besides the four valves 152, 154, 156, 158, which in turn are assigned to the four wheel brakes VL, VR, HL and HR, in each case at least one of the two further valve arrangements illustrated in FIG. 3, which each comprise two valves 178, 178′. By opening the valves 178, 178′ of at least one of these valve arrangements (in the context of a multiplex operation with the further valves 152, 154, 156, 158), the pedal reaction explained in relation to the embodiment according to FIG. 2 can be obtained. This is indicated by an arrow in FIG. 3.

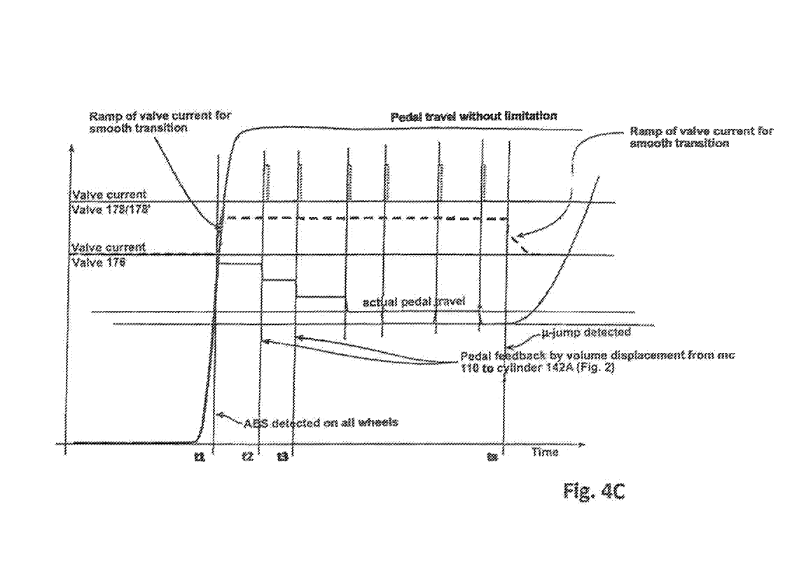

FIGS. 4A to 4C show diagrams which illustrate embodiments of the activation of some or a plurality of the valves 152, 154, 156, 158, 178, 178′ in multiplex operation. The corresponding activating concepts can be realized realized in the brake system 100 according to the above-described embodiments.

FIG. 4A shows in a combined diagram of the time profile of the brake pedal travel and of the activation (valve current) of the valve 176 provided between the master cylinder 110 and the simulation device 108. In FIG. 4A, the closed position of the valve 176 corresponds to the energized state of the latter.

According to FIG. 4A, it is detected at an instant t1 that an ABS control is required on all wheels of the vehicle owing to a low coefficient of friction of the roadway surface. In a conventional brake system based on the BBW principle, the further pedal travel would be defined exclusively by the characteristic of the simulation device 108 and (at least initially) unlimited.

In a departure from this conventional scenario, it is proposed, according to the approach presented here, to indicate to the driver haptically on the partially actuated brake pedal the presence of a roadway surface with a low coefficient of friction. For this, the brake pedal travel in the embodiment is initially limited and subsequently freed stepwise, in order to give the driver pedal feedback. Generally, the pedal travel can be adjusted in dependence on (for example indirectly proportional to) the roadway coefficient of friction. Thus, for example, it would be possible, as illustrated in FIG. 4A, to allow the pedal travel to become longer stepwise in the case of an increasing coefficient of friction.

After the requirement of an ABS control has been detected at the instant t1, firstly the valve 176 is energized in the manner of a ramp, in order to gradually shut off the hydraulic connection to the simulation device 108 and smoothly limit the pedal travel. It is assumed here that the hydraulic fluid displaced upon a brake pedal actuation cannot escape elsewhere. This corresponds, in the embodiment according to FIG. 2, to the closed state of the valves 174 and 178, so that the hydraulic fluid remains locked in the cylinder 142A. In the embodiment according to FIG. 3, this corresponds to a closed state of the two valve arrangements which respectively comprise the valve 178, 178′.

At the instants t2 and t3, in each case a certain increase of the roadway coefficient of friction is detected. For this reason, the valve 176 is in each case opened for a short time (i.e. put into the deenergized state). In the deenergized state, hydraulic fluid can escape into the simulation device 108. This is noticeable in FIG. 4A by a stepwise increase of the pedal travel at the instants t2 and t3. Finally, at the instant t4 there is detected a jump in the coefficient of friction, which makes it possible to end the ABS control. For this reason, the valve current is reduced in the manner of a ramp again and the valve 176 is correspondingly opened. This means that after a smooth transition the brake pedal travel increases as usual.

FIG. 4B shows a comparable scenario to FIG. 4A. FIG. 4B additionally shows the energizing of the valve 178, 178′ (cf. FIGS. 1 to 3), in order to close these valves.

In the embodiment according to FIG. 4B, the beginning of the ABS control mode is haptically indicated to the driver additionally by a to-and-fro pedal movement. The pedal movement therefore corresponds to the usual hydraulic pressure pulsations of an ABS control in a conventional brake system.

As illustrated in FIG. 4B, the valve 178/178′ is repeatedly energized for a short time (and opened during the energizing). The energizing of the valve 178/178′ takes place in cyclically recurring time slots and in multiplex operation with regard to the valves 152, 154, 156, 158 assigned to the wheel brakes. These valves 152, 154, 156, 158 too are cyclically energized in the context of the ABS control, in order to allow the ABS-typical pressure build-up, pressure maintaining and pressure reduction phases to proceed in a wheel-based manner. In total, a multiplex cycle therefore includes five time slots, one for each of the valves 152, 154, 156, 158, 178/178′.

As illustrated in FIG. 4B, at the instant t2 an energizing of the valve 178/178′ to open the latter takes place. In the opened state of the valve 178/178′ an actuation of the electromechanical actuator 124 takes place in order to displace a preset volume of hydraulic fluid and lengthen the pedal travel a little. In the embodiment according to FIG. 2, a volume displacement from the cylinder 142A into the hydraulic chamber 116 of the master cylinder 110 takes place for this purpose. In the embodiment according to FIG. 3, a displacement of a hydraulic fluid volume from the hydraulic chamber 116 of the master cylinder 110 into the cylinder 202 takes place.

Following this volume displacement, the pedal travel is kept at a constant value, i.e. limited, until an instant t3. At the instant t3, a volume displacement of the same size then takes place in the opposite direction. The processes taking place at the instants t2 and t3 can be repeated several times until at the instant tx the ABS control can be ended.

The pedal travel modulation shown in FIG. 4B allows the beginning of the ABS control to be haptically indicated to the driver at the brake pedal by limiting the pedal travel. During the ABS control, a pedal travel can be adjusted in dependence on the roadway coefficient of friction (cf. FIG. 4A). Furthermore, it is possible to generate a pulsating or vibrating pedal by activating the valve 178/178′, in order to haptically indicate the ABS control to the driver.

FIG. 4C illustrates in a similar diagram to FIG. 4B the scenario of an ABS control in the case of a rapid brake pedal actuation by the driver. Here, the valve 176 may possibly be closed too late due to the reaction time for the ABS detection, and this can result in an overshooting of the pedal travel. In other words, the pedal travel would be too long in relation to the roadway coefficient of friction. Here, by suitable activation of the valve 178/178′, the pedal travel can be brought back to the desired level by a suitable volume displacement. This means, in the embodiment according to FIG. 2, that a specific volume of hydraulic fluid is displaced from the chamber 116 of the master cylinder 110 into the cylinder 142A (at the instants t2, t3, etc.). In the embodiment according to FIG. 3, hydraulic fluid is conveyed from the cylinder 202 into the chamber 116 of the master cylinder 110.

Overall, the teaching presented here enables improved functionality of an electrohydraulic vehicle brake system in various respects. By extending the multiplex operation from four multiplex valves 152, 154, 156, 158, which are assigned to the wheel brakes, to one or more further valve arrangements, novel operating modes can be implemented. Thus, for example, it is possible according to various operating modes to give haptic feedback to the driver at the brake pedal, for instance by a pedal travel limitation. This haptic feedback may also indicate a dangerous situation, such as an ABS control mode.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. An electrohydraulic motor-vehicle brake system comprising
a master cylinder;
an electromechanical actuator for actuating a first piston accommodated in the master cylinder;
a receiving device for at least temporarily receiving hydraulic fluid from the master cylinder;
a set of electrically activatable valve arrangements, the set of valve arrangements comprising a respective first valve arrangement between the master cylinder and each one of a plurality of wheel brakes, and a second valve arrangement between the master cylinder and the receiving device; and
a control unit or control unit system, which is configured to activate at least one of the first valve arrangements and the second valve arrangement in multiplex operation.

2. The brake system according to claim 1, wherein
the receiving device is configured as a receiving cylinder and wherein a second piston coupled or couplable to a brake pedal is accommodated in the receiving cylinder.

3. The brake system according to claim 2, wherein
the control unit or control unit system is configured to act on the second piston by activating the second valve arrangement.

4. The brake system according to claim 3, wherein
the control unit or control unit system is configured to produce, by acting on the second piston, a pedal reaction indicating a driver-independent braking intervention.

5. The brake system according to one of claim 2, wherein
the receiving cylinder is coupled via a fluid line to a simulation device for hydraulic simulation of a pedal reaction characteristic of a service braking.

6. The brake system according to claim 5, wherein
a third valve arrangement, which has as an optional feature a preset or adjustable throttling function, is provided between the receiving cylinder and the simulation device.

7. The brake system according to claim 6, wherein
the second valve arrangement and the third valve arrangement are provided downstream of the receiving cylinder in hydraulic lines which run parallel to one another and lead respectively to the master cylinder and the simulation device.

8. The brake system according to claim 1, wherein
a fourth valve arrangement is provided in a fluid line between the receiving device and an unpressurised fluid reservoir.

9. The brake system according to claim 1, wherein
a fifth valve arrangement is provided in a fluid line between the master cylinder and an unpressurised fluid reservoir.

10. The brake system according to claim 1, wherein
the control unit or control unit system is configured to adjust hydraulic pressures individually in at least one of the wheel brakes and in the receiving device in multiplex operation.

11. The brake system according to claim 1, wherein
the first valve arrangements and the second valve arrangement are provided downstream of the master cylinder in hydraulic lines which run parallel to one another and lead respectively to the wheel brakes and the receiving device.

12. The brake system according to claim 1, wherein
the electromechanical actuator comprises an electric motor and a transmission coupled to the electric motor, the transmission being coupled to an actuating member acting on the first piston and the electric motor and the transmission being arranged at least partially concentrically with respect to the actuating member.

13. An electrohydraulic motor-vehicle brake system comprising
a master cylinder for hydraulic pressure generation in a push-through mode of the brake system;
an electromechanical hydraulic pressure generator for hydraulic pressure generation in a brake-by-wire mode of the brake system;
a set of electrically activatable valve arrangements, the set of valve arrangements comprising for each one of a plurality of wheel brakes a respective first valve arrangement between the master cylinder and the hydraulic pressure generator on the one hand and the wheel brake on the other hand and a second valve arrangement between the master cylinder and the electromechanical hydraulic pressure generator; and
a control unit or control unit system, which is configured to activate at least one of the first valve arrangements and the second valve arrangement in multiplex operation.

14. The brake system according to claim 13, wherein
the control unit or control unit system is configured to act on a piston, accommodated in the master cylinder and coupled or couplable to a brake pedal, by activating the second valve arrangement.

15. The brake system according to claim 14, wherein
the control unit or control unit system is configured to produce, by acting on the piston, a pedal reaction indicating a driver-independent braking intervention.

16. The brake system according to claim 13, wherein
the electromechanical hydraulic pressure generator comprises an electric motor, a transmission coupled to the electric motor, and a piston coupled to the transmission and accommodated in a hydraulic cylinder.

17. The brake system according to claim 13, wherein
the first valve arrangements each comprise exactly one electromagnetic valve.

18. The brake system according to claim 13, wherein
the control unit or control unit system is configured to activate the first valve arrangements during a driver-independent braking intervention.

19. An electrohydraulic motor-vehicle brake system comprising
a master cylinder;
an electromechanical actuator for hydraulic pressure generation in a brake-by-wire mode of the brake system;
a simulation device for producing a pedal reaction, the simulation device being configured to receive hydraulic fluid displaced upon a brake pedal actuation in the brake-by-wire mode;
a valve arrangement arranged upstream of the simulation device, in order to selectively shut off the reception of hydraulic fluid in the simulation device; and
a control unit or control unit system which is configured to activate the valve arrangement in a driving dynamics control mode of the brake system, in order to limit a brake pedal travel.

20. A method for operating an electrohydraulic motor-vehicle brake system, which comprises a master cylinder, an electromechanical actuator for actuating a first piston accommodated in the master cylinder, a receiving device for at least temporarily receiving hydraulic fluid from the master cylinder, a set of electrically activatable valve arrangements, and a plurality of wheel brakes, the set of valve arrangements comprising a respective first valve arrangement between the master cylinder and each wheel brake, and a second valve arrangement between the master cylinder and the receiving device, comprising the step of:
activating at least one of the first valve arrangements and the second valve arrangement in multiplex operation.

21. The method according to claim 20, wherein
hydraulic pressures are adjustable or adjusted individually in at least one of the wheel brakes and in the receiving device in multiplex operation.

22. The method according to claim 20, wherein
the receiving device is configured as a receiving cylinder and a second piston is accommodated in the receiving cylinder and coupled to a brake pedal is provided, the second valve arrangement being actuated in multiplex operation, in order to act on the second piston.

23. The method according to claim 21, wherein
the acting on the second piston produces a pedal reaction indicating a driver-independent braking intervention.

24. The method according to claim 22, wherein
the acting on the second piston realizes a pedal travel limitation, in order to indicate a roadway coefficient of friction via the pedal travel.

25. A method for operating an electrohydraulic motor-vehicle brake system, which comprises a master cylinder for hydraulic pressure generation in a push-through mode of the brake system, an electromechanical hydraulic pressure generator for hydraulic pressure generation in a brake-by-wire mode of the brake system, a set of electrically activatable valve arrangements and a plurality of wheel brakes, the set of valve arrangements comprising a respective first valve arrangement between the master cylinder and the electromechanical hydraulic pressure generator on the one hand and each wheel brake on the other hand and a second valve arrangement between the master cylinder and the electromechanical hydraulic pressure generator (124), comprising the step of:
activating at least one of the first valve arrangements and the second valve arrangement in multiplex operation.

26. The method according to claim 25, wherein
by activating the second valve arrangement, a piston, accommodated in the master cylinder and coupled or couplable to a brake pedal, is acted on.

27. The method according to claim 27, wherein
by acting on the piston, a pedal reaction indicating a driver-independent braking intervention is produced.

28. The method according to claim 26, wherein
the acting on the piston realizes a pedal travel limitation, in order to indicate a roadway coefficient of friction via the pedal travel.

29. The method according to claim 25, wherein
an actuation of the first valve arrangements is prioritised over an actuation of the second valve arrangement in the multiplex operation.

30. A method for operating an electrohydraulic motor-vehicle brake system, which comprises a master cylinder, an electromechanical actuator for hydraulic pressure generation in a brake-by-wire mode of the brake system, a simulation device for producing a pedal reaction, the simulation device being configured to receive hydraulic fluid displaced upon a brake pedal actuation in the brake-by-wire mode, and a valve arrangement arranged upstream of the simulation device, in order to selectively shut off the reception of hydraulic fluid in the simulation device, comprising the step of:
activating the valve arrangement in a driving dynamics control mode of the brake system, in order to limit a brake pedal travel.

31. A computer program product with program code means for carrying out the method according to claim 20 when the computer program product runs on at least one processor.

32. A motor-vehicle control unit or control unit system, comprising the computer program product according to claim 31.

33. The brake system according to claim 1, wherein
the first valve arrangements each comprise exactly one electromagnetic valve.

34. The brake system according to claim 1, wherein
the control unit or control unit system is configured to activate the first valve arrangements during a driver-independent braking intervention.

35. The method according to claim 20, wherein
an actuation of the first valve arrangements is prioritised over an actuation of the second valve arrangement in the multiplex operation.

36. A computer program product with program code means for carrying out the method according to claim 25 when the computer program product runs on at least one processor.

37. A motor-vehicle control unit or control unit system, comprising the computer program product according to claim 36.

38. A computer program product with program code means for carrying out the method according to claim 30 when the computer program product runs on at least one processor.

39. A motor-vehicle control unit or control unit system, comprising the computer program product according to claim 38.
